(19) United States
(12) Patent Application Publication
(10) Pub. No.: US 2016/0001303 A1
(43) Pub. Date: Jan. 7, 2016

(54) Discharge Nozzle for Nozzle Separator

(71) Applicant: Andritz Frautech S.r.l., Schio (IT)

(72) Inventors: Daniele Casa, Schio (IT); Robert Chaffiotte, Madison, CT (US); Damon Cecchellero, Schio (IT); lvan Holzer, Graz (AT); Valeria Motterle, Schio (IT); Diego Accelli, Schio (IT)

(73) Assignee: ANDRITZ FRAUTECH S.R.L., Schio (IT)

(21) Appl. No.: 14/790,612

(22) Filed: Jul. 2, 2015

(30) Foreign Application Priority Data
Jul. 4, 2014 (EP) 14002296.3

(51) Int. Cl. B04B 11/02

(52) U.S. Cl. CPC B04B 11/02

(57) ABSTRACT

The invention relates to an outlet nozzle assembly (10) for use with a rotor of a centrifuge, especially for a nozzle separator (1), consisting of a cylindrical nozzle holder (11) to be mounted into a bore (12) in the bowl (4) of the centrifuge (1), a nozzle (13) to be fixed to the nozzle holder (11) and a wear tube (14) fitted into the nozzle (13). It is mainly characterized in that the nozzle (13) is mounted from the outside to the nozzle holder (11), the nozzle (13) has an axis (21) arranged in an acute angle (α) to the normal to the axis (20) of the bore (12) in the bowl (4) and that the opening (23) to the nozzle (13) is arranged asymmetrically in the nozzle holder (11), i.e., at a distance from the axis (20). With such a design high concentrated mineral suspension can be treated in a centrifuge (1) to separate different fractions of solids.

### BACKGROUND

The invention relates to an outlet nozzle assembly for use with a centrifuge rotor, especially for a nozzle separator.

There exist a number of nozzle designs for nozzle separators, e.g., U.S. Pat. No. 2,060,239 and U.S. Pat. No. 2,695,748. Despite updates, such as those shown in U.S. Pat. No. 6,216,959 and U.S. Pat. No. 7,614,995, nozzles continue to have a number of problems, including wear and resultant needs for replacement. Such wear is especially prevalent when the centrifuge rotor is used in conjunction with mineral applications, i.e. when separating solid/liquid mixtures with a high amount of solids. Some of the existing designs can handle solid/liquid mixtures up to a specific gravity of approx. 1.0 to 1.3 g/l (kg/m³). Mixtures with higher gravity however cannot be treated. Additionally, even mixtures that can be treated can create significant wear on any nozzles used with the separation. These nozzles, when mounted securely, can be difficult or expensive to replace. Nozzles not mounted as securely may not provide sufficient strength for the forces generated within the nozzles and surrounding walls of the centrifuge bowl during operation.

### SUMMARY

The goal of the invention is to avoid the drawbacks of the state of the art and to allow separation of solid/liquid mixtures of a specific gravity greater than that of the state of the art. The invention is intended to allow separation of a variety of mixtures, including those up to 2.0 g/l (kg/m³) specific gravity and beyond. The invention is also intended to reduce wear on the nozzle while also allowing for simple removal of the nozzle when needed. Further, the invention is intended to allow for smooth flow into the nozzle while maintaining strength in the nozzle assembly and bowl.

The invention is thus characterized in that the nozzle is mounted from the outside to the nozzle holder, the nozzle has an axis arranged in an acute angle to the axis of the bore in the bowl, and the opening to the nozzle is arranged asymmetrically in the nozzle holder, i.e. at a distance offset from the axis. With this design, the wear occurring in the nozzle holder due to the change of flow direction and thus also impingement of the solid particles against the wall can be minimized. With the outside mounting it is also easy to exchange the nozzle and the wear tube from the outside of the separator without dismantling the entire apparatus. Further, the nozzle diameter can be easily varied to accommodate different particle sizes.

A further advantageous embodiment of the invention is characterized in that the wear tube is of tungsten carbide. With such material, there is a long service life of the wear tube even when it is used in mineral applications of the separator.

Another favourable embodiment of the invention is characterized in that the axis of the nozzle has an angle of approximately 10° to 45°, preferably approx. 20°, to the normal to the axis of the bore in the bowl of the centrifuge. Such an angle allows for minimal interference, and ideally no interference at all, of the various jets of the different neighbouring nozzles. Further, there can be energy recovery for the drive of the separator. This range of the angle has highly advantageous energy recovery and allows for a large number of nozzles around the circumference of the bowl of the separator.

A further favourable embodiment of the invention is characterized in that a fixation method, such as a fixing screw, is provided to releasably fix the nozzle holder to the bowl. In a preferred embodiment, the nozzle holder is placed in the bowl from the inside while being fixed from the outside of the bowl. The nozzle holder can thus be fitted into the bore of the bowl tightly so that there is no leak of suspension to the outside except as directed through the nozzle.

Another advantageous embodiment of the nozzle assembly according to the invention is characterized in that the nozzle holder is made of tungsten carbide or similar wear resistant material. When the nozzle holder is also manufactured of a high wear resistant material, the service life of the nozzle holder will also increase dramatically, especially compared to other materials when used in conjunction with high solid concentrations of the mixtures to be treated.

### BRIEF DESCRIPTION OF THE DRAWING3

The invention is now disclosed in detail with reference to an embodiment shown in the accompanying drawing, where:

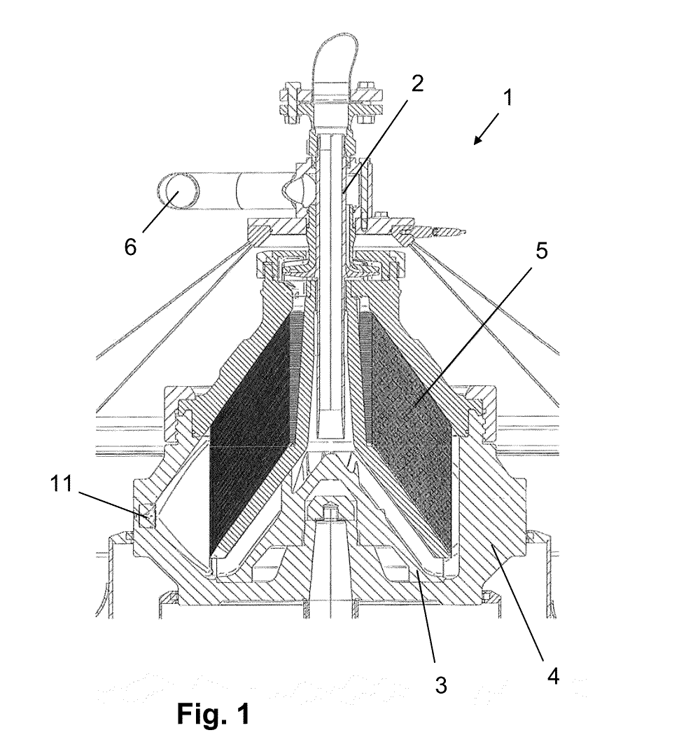

FIG. 1 shows a section of a nozzle separator where the invention is used;

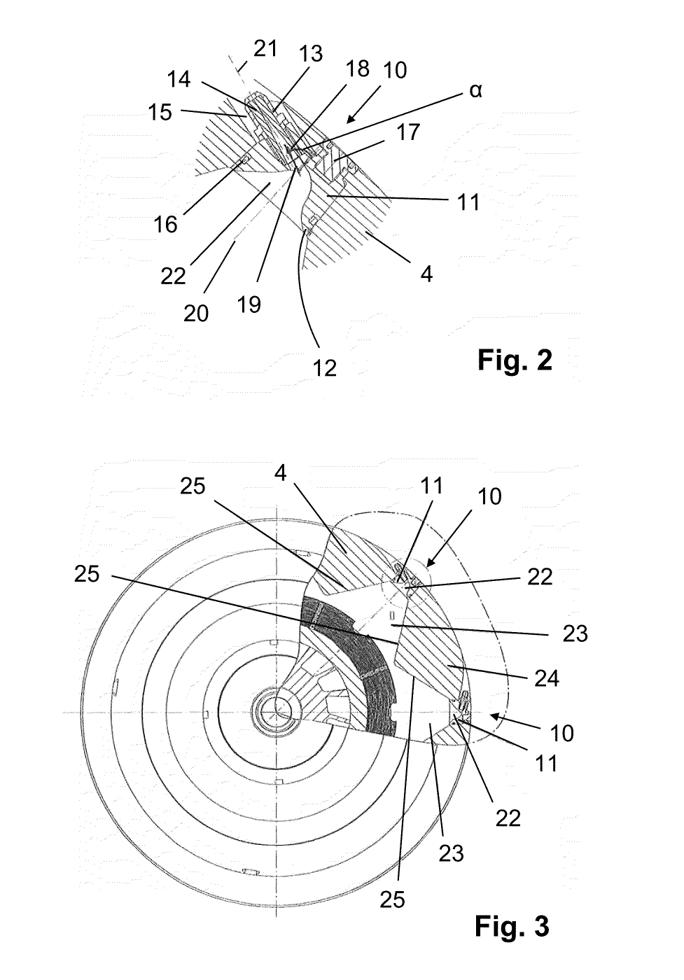

FIG. 2 shows a section of the bowl wall with a nozzle assembly in accordance with the invention; and

FIG. 3 shows a top view of the bowl with breakout section showing a region of two nozzle assemblies.

### DETAILED DESCRIPTION

FIG. 1 shows a nozzle separator 1 with a feed pipe 2 for the solid/liquid mixture. This mixture is directed to an accelerator 3 which directs the mixture to the free space in the rotating drum or bowl 4. The mixture is separated in the disc stack, whereby a heavier fraction is discharged through nozzles and a lighter fraction is discharged through discharge pipe 6. Due to the rotation, the lighter fraction concentrates in the centre and the heavier fraction is sent to the circumference.

FIG. 2 shows a section through the wall of the bowl 4 with a nozzle assembly 10 according to the invention. The nozzle assembly 10 consists of a nozzle holder 11 to be mounted into a bore 12 in the bowl 4 of the centrifuge 1. In an exemplary embodiment, the nozzle holder 11 is cylindrical. Further, the nozzle assembly 10 has a nozzle 13 to be fixed to the nozzle holder 11 and a wear tube 14 fitted into the nozzle 13. The entire nozzle assembly 10 fits into a recess 15 in the bowl 4, so that no part of the nozzle 13 extends outside the outer circumference of the bowl 4. Nozzle holder 11 is pressed into bore 12 in the bowl 4. There it is sealed against leakage to the outside, such as by conventional ring seals 16. As the nozzle holder 11 does not normally need to be changed, especially if manufactured from wear resistant material, seal 16 always remains tight.

After mounting of the nozzle holder 11 from the inner side of the bowl 4 it is releasably attached by a fixation means, holding it in the correct position. A fixation means such as a fixation screw 17 may be used from the outside, allowing for easier attachment and removal as well as providing additional location or alignment. A wear tube 14 is inserted into nozzle 13. Nozzle 13 is attached to the nozzle holder 11, such as by being screwed in from the outside, thereby connecting the channel 18 of the nozzle 13 with the channel 19 in the nozzle holder 11.

The axis 20 of the nozzle holder and the axis 21 of the nozzle 13 (and wear tube 14) are arranged at an acute angle a (where a is measured between axis 21 and the normal to axis 20). This angle is selected so that the jet of the nozzle 13 will not interfere with the jet of any other nozzle 13 of the centrifuge 1, even when there are numerous nozzles 13 and thus the distance between the nozzles 13 along the circumference of the bowl 4 may be relatively small. A range of the angle a of 10° to 45°, preferably approx. 20°, has proven especially advantageous for the energy recovery of the separator. As the wear tube 14 can be manufactured of a wear resistant material, e.g., tungsten carbide, a long service life can be achieved. However, it is easy to replace the wear tube 14 by simply dismounting nozzle 13 from the outside (such as through a service opening in the outside casing of the separator) and changing the insert. An additional advantage of such a design is that it allows wear tubes 14 with different diameters of the inner bore to be inserted, so the nozzle 13 can also be adjusted for different products or product concentrations. It can be seen that the opening 22 in the nozzle holder 11, which collects the suspension and directs it to the channel 19 connected to the nozzle 13, is formed asymmetrical in a preferred embodiment. The bottom of this opening 22 is offset at a distance from the axis 20 of the nozzle holder 11. Due to this, the change of the flow direction to the nozzle 13 is smoother than with nozzles of the state of the art and the impact of the flow is softer, thus the possible wear of the nozzle holder 11 is reduced. This can be reduced further when it is manufactured of a wear resistant material like tungsten carbide.

FIG. 3 shows the arrangement of two nozzle assemblies 10 according to the invention in a cut through of bowl 4. Here it can be seen that the bowl wall 24 has openings 23 which direct the suspension into the individual openings 22 of the nozzle holder 11 along the interior wall surfaces 25. Between the nozzles 13 and nozzle holders 11 there is a solid part 24 of the bowl 4 such as to provide a sufficiently strong bowl to allow for high revolutions (including up to 4000 rpm or higher).

The invention is not limited by the examples described. Among other variations, the nozzle holder, nozzle, and wear tube can be made of any material resisting the wear of the product to be treated and can be selected accordingly as well as for lower costs or improved component life.

1. An outlet nozzle assembly (10) for use with a rotor of a centrifuge, especially for a nozzle separator (1) comprising:
cylindrical nozzle holder (11) to be mounted into a bore (12) in the bowl (4) of the centrifuge (1);
a nozzle (13) to be fixed to the nozzle holder (11); and
a wear tube (14) fitted into the nozzle (13);
wherein the improvement comprises that the nozzle (13) is mounted from the outside to the nozzle holder (11), the nozzle (13) has an axis arranged in an acute angle (a) to the normal of the axis (20) of the bore (12) in the bowl (4), and the opening (22) to the nozzle (13) is arranged asymmetrically in the nozzle holder (11).

2. Outlet nozzle assembly according to claim 1, wherein the wear tube (14) is tungsten carbide.

3. Outlet nozzle assembly according to claim 1, wherein the axis (21) of the nozzle (13) has an angle (a) of 10° to 45° to the normal of the axis (20) of the bore (12) in the bowl (4) of the centrifuge.

4. Outlet nozzle assembly according to claim 3, wherein the angle (α) is 20°.

5. Outlet nozzle assembly according to claim 1, including a fixing screw (17) configured to fix the nozzle holder (11) to the bowl (4).

6. Outlet nozzle assembly according to claims 1, wherein the nozzle holder (11) is made of tungsten carbide or similar wear resistant material.

7. Outlet nozzle assembly according to claim 1, wherein the nozzle holder (11) is releasably fixed to the bowl (4) from the outside of the bowl (4).

8. Outlet nozzle assembly according to claim 1, wherein the cross-section of the nozzle holder (11) is asymmetrical.

9. Outlet nozzle assembly according to claim 1, wherein at least one asymmetrical interior surface of the nozzle holder (11) creates an offset tangent to the axis (21) of the nozzle (13).

10. Outlet nozzle assembly according to claim 1, wherein the nozzle holder (11) defines a smooth fluid flow path transitioning from an opening (23) in the bowl (4).

11. Outlet nozzle assembly according to claim 1, wherein the nozzle holder (11) is configured to be placed within the bowl (4) from the inside of the bowl (4).
